(19) United States
(12) Patent Application Publication
(10) Pub. No.: US 2020/0009016 A1
(43) Pub. Date: Jan. 9, 2020

(54) IV CONTAINER FOR PRECISE MEASUREMENT AND ADMINISTRATION

(71) Applicant: Mary Ellen Stewart, Mobile, AL (US)

(72) Inventor: Mary Ellen Stewart, Mobile, AL (US)

(21) Appl. No.: 16/030,604

(22) Filed: Jul. 9, 2018

(51) Int. Cl. A61J 1/18; A61J 1/10; A61J 1/14

(52) U.S. Cl. CPC A61J 1/18; A61J 1/10; A61J 2200/76; A61J 1/1475; A61J 1/1462

(57) ABSTRACT

An IV container for precise measurement and dispensing of fluid contained in the IV container. This IV container has an upper fluid-containing portion to contain and measure a first quantity of fluid. The upper fluid-containing portion has a first cross-sectional area, and a first plurality of fluid measurement markings along a side of the upper fluid-containing portion that represent measurement units of a first size. A lower fluid-containing portion is in fluid communication with the upper fluid-containing portion, and can contain and measure a second lesser quantity of fluid. The lower fluid-containing portion has a second cross-sectional area that is less than the first cross-sectional area. The lower fluid-containing portion has a second plurality of measurement markings along a side of the lower fluid-containing portion that represent measurement units of a second size that's smaller than the units of the upper fluid containing portion, and therefore provides enhanced measurement precision.

### FIELD OF THE INVENTION

This invention relates generally to IV containers, and more particularly to IV containers with precise measurement features.

### BACKGROUND OF THE INVENTION

Intravenous (IV) infusions have been performed for over 200 years. Plastic or flexible IV bags have been used for at least the past 60 years. Errors and inaccuracies in fluid volume infused can result in serious negative side effects.

The popular IV container of today is a flat plastic bag without accurate markings. In the case of time sensitive meds, current IV bags require repeated checks by the nurse to adjust the rate of infusion of a medication so as to ensure that the medication is flowing into the patient at a target rate needed to ensure that the full amount of medication prescribed by the Doctor is administered by a target time. It is common for a nurse to need to repeatedly go back into the patient's room to adjust the rate of infusion of the meds, which results in an inefficient use of the nurse's time that could be better spent helping other patients.

Presently, the level of accuracy exhibited when performing IV infusions and administration has not been optimized. A nurse, or other health practitioner, sometimes has to deal with overfilled and/or under filled bags. This is because pharmacists fill IV bags, not nurses. And pharmacists don't really care that the additives in the bag will increase the volume, even though this can create perplexing problems for the nurse when attempting to determine the correct rate of administration of a time-sensitive drug, i.e., a drug that must be administered within a specific period of time.

For example, methotrexate is a chemotherapeutic agent that must be administered within a specific period of time, e.g., 24 hours.

To determine the correct rate of administration of the medication in the IV bag, the nurse must estimate how much solution is in the IV bag that has been prepared and filed by the pharmacist or manufacturer. So, more accuracy in the fluid in container will help to get the chemotherapeutic agent in within the specified amount of time.

However, due to the shape and lack of accurate volumetric measurement markings on present IV bags, it is difficult for the nurse to determine the volume of medication and/or nutrient solution contained in the bag. Therefore, it is difficult to precisely calculate the amount of time needed for a target quantity of time-sensitive medication to be fully infused by a target time. Consequently, when using present IV bags, careful and repeated monitoring and possible adjustment by the nurse of the rate of infusion is essential, since even the most vigilant nurse is at risk of making inaccurate fluid estimations due to the crude volumetric measurement markings provided on present IV containers.

### SUMMARY OF THE INVENTION

The IV container for precise measurements of the invention significantly increases the accuracy of the administration rate and time for the nurse or other healthcare practitioner to administer medications and other fluids using an IV container. The modified shape of the IV container, and volumetric measurement markings that enable more precise volumetric measurements than present IV containers, provide advantages when administering time-sensitive medications, and quantitative IV nutrition.

Regarding IV nutrition, the IV container for precise measurements of the invention enables the last amounts of parenteral nutrition fluid not yet infused into the patient to be measured for further planning for the patient. Regarding administration of time-sensitive infusions, such as IV antibiotics, the increased accuracy provided by the IV container for precise measurements makes it easier and less time-consuming for nurses and other health practitioners to ensure correct rate and timing of IV drug administration.

The IV container for precise measurements contains more precise markings for volume on a portion of the IV container that contains a smaller volume of fluid, so the need for estimation and approximation while administering fluids is substantially reduced. The multi-section shapes and closer-spaced measurement markings together enable more accurate fluid administration measurement, thereby reducing mistakes.

The volume accuracy for administering medications using the IV container for precise measurements increases the effectiveness of medication administration, while reducing risk of over- or under-medicating, thereby reducing undesirable side effects. Further better results can be achieved when administering medications using the IV container of the invention when time is of the essence, since when dealing with the time sensitive infusions, it is best to administer meds as prescribed, i.e., a precise amount of medication administered within a precise period of time.

The accuracy of the IV container for precise measurements of the invention assures reduced time required by the healthcare practitioner due to less time needed to monitor and adjust the rate of administration of IV medications to the patient.

A general aspect of the invention is an IV container for precise measurement and dispensing of fluid contained in the IV container. The IV container includes: an upper fluid-containing portion configured to contain and measure a first quantity of fluid, the upper fluid-containing portion having a first cross-sectional area, the upper fluid-containing portion having a first plurality of fluid measurement markings along at least a portion of a side of the upper fluid-containing portion; a lower fluid-containing portion in fluid communication with the upper fluid-containing portion, the lower fluid-containing portion configured to contain and measure a second quantity of fluid, the lower fluid-containing portion having a second cross-sectional area that is less than the first cross-sectional area, the lower fluid-containing portion having a second plurality of fluid measurement markings along at least a portion of a side of the lower fluid-containing portion; a plurality of ports in fluid communication with the lower fluid-containing portion, the plurality of ports configured to enable input and output of fluids; and a tab, connected to the upper fluid-containing portion, the tab configured to be suspended from an IV stand.

In some embodiments, the IV container further includes: a tapered intermediate fluid-containing portion in fluid communication with both the upper fluid-containing portion and the lower fluid-containing portion.

In some embodiments, the tapered intermediate fluid-containing portion has a conical shape.

In some embodiments, the tapered intermediate fluid-containing portion has a third plurality of fluid measurement markings along at least a portion of a side of the tapered intermediate fluid-containing portion, each pair of neighboring markings of the third plurality of fluid measurement markings representing a same quantity of fluid.

In some embodiments, the first plurality of fluid measurement markings along at least a portion of a side of the upper fluid-containing portion represent measurement units of a first size; and the second plurality of fluid measurement markings along at least a portion of a side of the lower fluid-containing portion represent measurement units of a second size that is smaller than the measurement units of the first size.

In some embodiments, the upper fluid-containing portion is configured to contain a greater quantity of fluid than the lower fluid-containing portion is configured to contain.

In some embodiments, the upper fluid-containing portion and the lower fluid-containing portion include at least a portion made of a translucent material.

In some embodiments, the upper fluid-containing portion and the lower fluid-containing portion are made of a flexible material.

In some embodiments, the upper fluid-containing portion and the lower fluid-containing portion are made of glass.

In some embodiments, the upper fluid-containing portion and the lower fluid-containing portion have a substantially cylindrical shape.

In some embodiments, the upper fluid-containing portion and the lower fluid-containing portion each have a substantially flat shape when empty, each portion having a seam that is configured to seal in fluid contained therein.

In some embodiments, the plurality of ports includes two ports.

Another general aspect of the invention is an IV container for precise measurement and dispensing of fluid contained in the IV container. This IV container includes: a flexible translucent upper fluid-containing portion configured to contain and measure a first quantity of fluid, the flexible translucent upper fluid-containing portion having a first cross-sectional area, the flexible translucent upper fluid-containing portion having a first plurality of fluid measurement markings along at least a portion of a side of the flexible translucent upper fluid-containing portion; a flexible translucent lower fluid-containing portion in fluid communication with the flexible translucent upper fluid-containing portion, the flexible translucent lower fluid-containing portion configured to contain and measure a second quantity of fluid, the flexible translucent lower fluid-containing portion having a second cross-sectional area that is less than the first cross-sectional area, the flexible translucent lower fluid-containing portion having a second plurality of fluid measurement markings along at least a portion of a side of the flexible translucent lower fluid-containing portion; a plurality of ports in fluid communication with the flexible translucent lower fluid-containing portion, the plurality of ports configured to enable input and output of fluids; and a tab, connected to the flexible translucent upper large fluid-containing portion, the tab configured to be suspended from an IV stand.

In some embodiments, the flexible translucent lower fluid-containing portion is configured to contain and measure a second quantity of fluid that is less than the first quantity of fluid.

In some embodiments, the first plurality of fluid measurement markings along at least a portion of a side of the flexible translucent upper fluid-containing portion represent measurement units of a first size; and the second plurality of fluid measurement markings along at least a portion of a side of the flexible translucent lower fluid-containing portion represent measurement units of a second size that is smaller than the measurement units of the first size.

In some embodiments, the IV container further includes: a flexible translucent tapered intermediate fluid-containing portion in fluid communication with both the flexible translucent upper fluid-containing portion and the flexible translucent lower fluid-containing portion.

In some embodiments, the flexible translucent tapered intermediate fluid-containing portion has a third plurality of fluid measurement markings along at least a portion of a side of the flexible translucent tapered intermediate fluid-containing portion, each pair of neighboring markings of the third plurality of fluid measurement markings representing a same quantity of fluid.

In some embodiments, the flexible translucent upper fluid-containing portion and the flexible translucent lower fluid-containing portion have a substantially flat shape when empty, each portion having a seam that is configured to seal in fluid contained therein.

### BRIEF DESCRIPTION OF THE DRAWINGS

Many additional features and advantages will become apparent to those skilled in the art upon reading the following description, when considered in conjunction with the accompanying drawings, wherein:

FIG. 1 is a perspective view of a cylindrical embodiment of the IV container for precise measurements showing an IV container with an upper portion, a tapered intermediate portion, and a lower portion.

FIG. 2 is a front view of the IV container for precise measurements of FIG. 1, showing the tab to be held by an IV stand, the tapered intermediate portion between the upper and lower portions, the ports for fluid administration and medication input, and showing more closely spaced markings on the lower portion than on the upper portion. This view can also represent an IV bag embodiment.

FIG. 3 is a side view of an embodiment of the IV container for precise measurements, showing accurate measurement markings and numbered milliliter markings on the upper, intermediate, and lower portions. This view can also represent an IV bag embodiment.

FIG. 4 is a bottom view of the IV container for precise measurements of FIG. 1, showing the IV container with a cylindrical upper fluid-containing portion, an intermediate fluid-containing portion, and a cylindrical lower fluid-containing portion, and the ports for fluid administration and medication input.

FIG. 5 is a front view of an alternate embodiment of the IV bag for precise measurements, showing an IV bag seamed on the outer perimeter of the IV bag with an upper fluid-containing portion and a lower fluid-containing portion, also showing accurate measurement markings and numbered milliliter markings.

FIG. 6 is a side view of the IV bag for precise measurements of FIG. 5, showing the upper fluid-containing portion and the lower fluid-containing portion.

### DETAILED DESCRIPTION

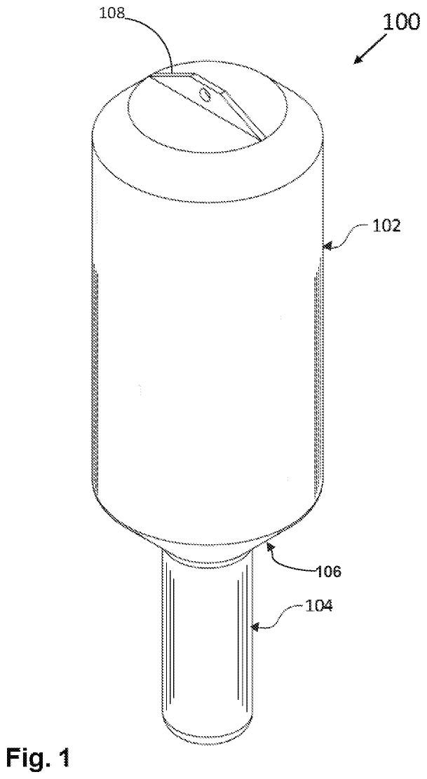

With reference to FIG. 1, a translucent IV container 100 has a cylindrical upper large fluid-containing portion 102, and a cylindrical lower smaller fluid-containing portion 104, which are in fluid communication via a tapered intermediate fluid-containing portion 106. In this embodiment, the tapered intermediate fluid-containing portion 106 has a conical shape with 45 degree angle. Other tapered shapes are useful, and other conical shapes, such as those having 30 degree or 60 degree angles, or any angles there between are also useful. There is also a tab 108 for suspending the container 100 from an IV stand.

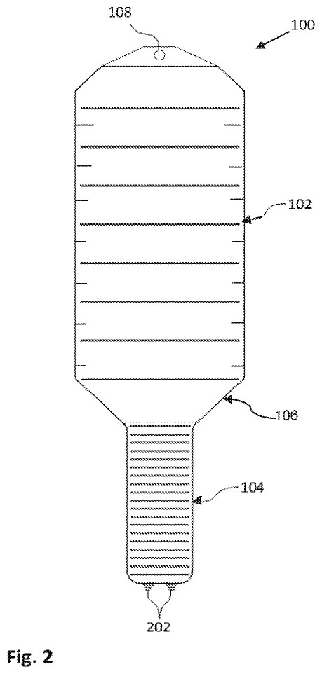

With reference to FIG. 2, a side view of the translucent IV container 100 is shown, again showing the upper large fluid-containing portion 102, the lower smaller fluid-containing portion 104, and the tapered intermediate fluid-containing portion 106. Two fluid ports 202 for fluid administration and medication input are at the bottom of the lower smaller fluid-containing portion 104. The tab 108 is again shown for suspending the container 100 from an IV stand (not shown), the tab 108 extending from the top of the upper large fluid-containing portion 102. Note that in this figure measurement markings are shown, without specifying particular measurement intervals. In fact, many different sized measurement intervals can be used, depending on the size of the IV container, and the measurement precision needed. This view can also represent an embodiment of an IV bag according to the invention.

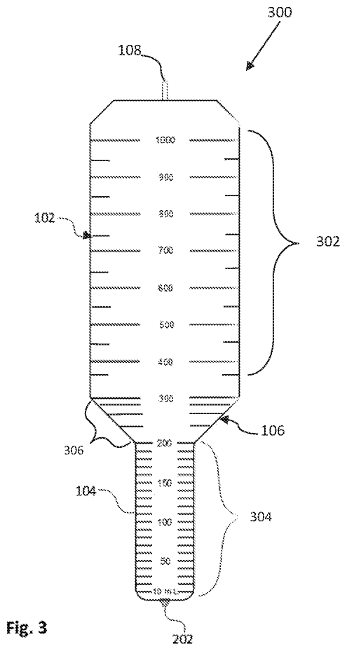

With reference to FIG. 3, the translucent IV container 300 for accurate measurement and administration of fluids includes a lower small fluid-containing portion 104 with precise closely-spaced markings 304, e.g., in 10 ml increments, for more accurate measurement of smaller amounts of fluids, and an upper large fluid-containing portion 102 with precise but more widely-spaced markings 302, e.g., in 50 ml increments, for accurate measurement of larger amounts of fluids. The tapered intermediate section 106 has progressively spaced markings 306, the space between any two neighboring pair of markings representing 25 ml of fluid. The markings 306 represent equi-volume markings that are progressively spaced along the tapered intermediate section 106.

Two ports 202 (only one visible in this view) for fluid administration and medication input are located at the bottom of the lower smaller fluid-containing portion 104. Also, a tab 108 for hanging the container 100 from an IV stand (not shown) is attached to the top of the upper large fluid-containing portion 102. This view can also represent an embodiment of an IV bag according to the invention.

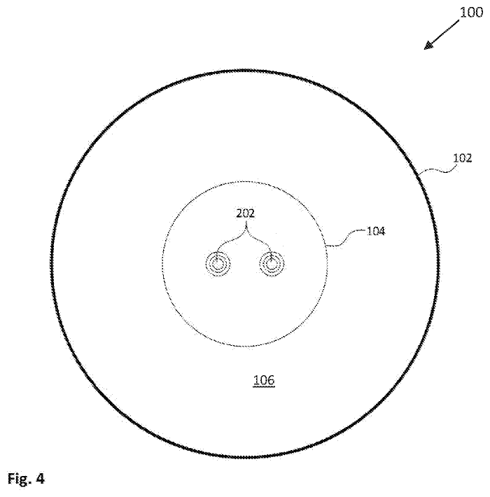

With reference to FIG. 4, a bottom view is shown of the container 100, showing the cylindrical upper large fluid-containing portion 102, which is above the cylindrical lower smaller fluid-containing portion 104, and the intermediate portion 106. The cylindrical lower smaller fluid-containing portion 104 has two ports extending downward for fluid administration and medication input 202. The two ports 202 are each in fluid communication with the bottom of the cylindrical lower fluid-containing portion 104.

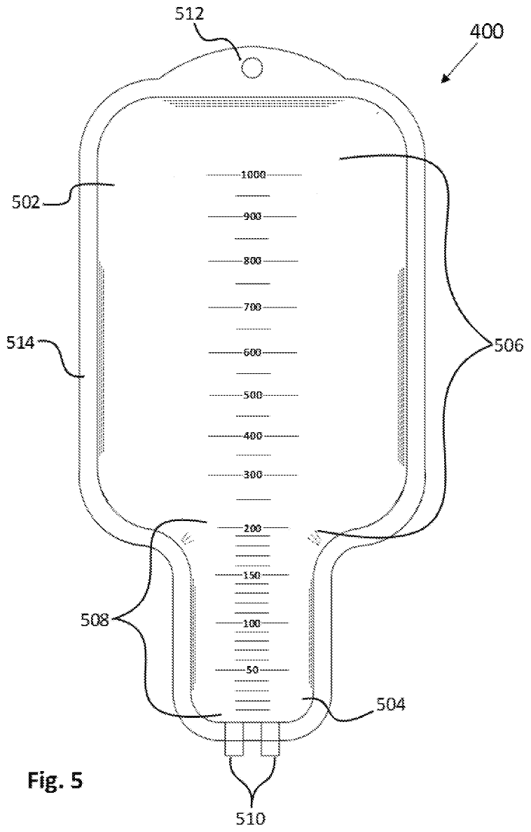

FIG. 5 shows a side view of another embodiment of a translucent flexible IV bag 400 having an upper large fluid-containing portion 502, and a lower smaller fluid-containing portion 504. The upper large fluid-containing portion 502 has precise widely-spaced markings 506, e.g., 50 ml, for accurate measurement of bulk fluids, and the lower smaller fluid-containing portion 504 has precise more closely-spaced markings 508, e.g., 10 ml, for more precise measurements of smaller quantities of fluids. Two ports 510 for fluid administration and medication input are attached in fluid communication to the bottom of the lower fluid-containing portion 504. Also, a tab 512 extends from the top of the bag 400 that can be used to mount the bag 400 on an IV stand (not shown). The IV container has a seam 514 around the outside perimeter of the IV bag 400 that serves to seal in the fluid contents of the container 400.

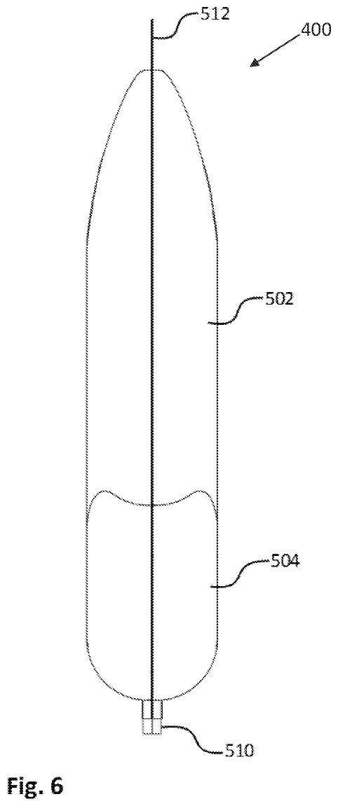

With reference to FIG. 6, a side view of the bag 400 of FIG. 5 is shown. The upper large fluid-containing portion 502 is in fluid communication with the lower smaller fluid-containing portion 504, which in turn is in fluid communication with two ports 510 (one visible in this view) that are included to provide fluid administration and medication input routes. The tab 512 extends upward from the upper large fluid-containing portion 502, the tab 512 being useful for hanging the bag 400 from a hook on an IV stand (not shown).

The IV bag embodiments of the invention can be made from one of: polyvinyl chloride (PVC), Ethylene vinyl acetate, Polypropylene, Copolyester ether. All polypropylene bags contain other materials added to make them more flexible and durable. Pure polypropylene is too brittle and stiff. Combining polypropylene, or other polyolefin resins, to a copolyester ether, Ecdel™ elastomer, available as resin from Eastman Chemical Co., Kingsport, Tenn.). Monolayer or multilayer films incorporating Ecdel™ elastomer are available. When used in multilayer films, Ecdel™ as the outer layer provides toughness, clarity, and flexibility.

The bottle shown in FIGS. 1 and 4 can be made of either glass, or plastic, such as PET. Nurses are presently provided with both glass and plastic IV bottles. IV fluids are presently available in plastic and glass bottles. It is common for bags to be used for continuous drips.

The IV container for precise measurement and dispensing of fluid contained in the IV container can be made to accommodate any of the standard and non-standard sizes of IV containers available today, such as 1000 ml, 500 ml, etc.

Other modifications and implementations will occur to those skilled in the art without departing from the spirit and the scope of the invention as claimed. Accordingly, the above description is not intended to limit the invention, except as indicated in the following claims.

What is claimed is:

1. An IV container for precise measurement and dispensing of fluid contained in the IV container, the IV container comprising:
an upper fluid-containing portion configured to contain and measure a first quantity of fluid,
the upper fluid-containing portion having a first cross-sectional area,
the upper fluid-containing portion having a first plurality of fluid measurement markings along at least a portion of a side of the upper fluid-containing portion;
a lower fluid-containing portion in fluid communication with the upper fluid-containing portion, the lower fluid-containing portion configured to contain and measure a second quantity of fluid,
the lower fluid-containing portion having a second cross-sectional area that is less than the first cross-sectional area,
the lower fluid-containing portion having a second plurality of fluid measurement markings along at least a portion of a side of the lower fluid-containing portion;
a plurality of ports in fluid communication with the lower fluid-containing portion, the plurality of ports configured to enable input and output of fluids; and
a tab, connected to the upper fluid-containing portion, the tab configured to be suspended from an IV stand.

2. The IV container of claim 1, further comprising:
a tapered intermediate fluid-containing portion in fluid communication with both the upper fluid-containing portion and the lower fluid-containing portion.

3. The IV container of claim 2, wherein the tapered intermediate fluid-containing portion has a conical shape.

4. The IV container of claim 2, wherein the tapered intermediate fluid-containing portion has a third plurality of fluid measurement markings along at least a portion of a side of the tapered intermediate fluid-containing portion, each pair of neighboring markings of the third plurality of fluid measurement markings representing a same quantity of fluid.

5. The IV container of claim 1, wherein:
the first plurality of fluid measurement markings along at least a portion of a side of the upper fluid-containing portion represent measurement units of a first size; and
the second plurality of fluid measurement markings along at least a portion of a side of the lower fluid-containing portion represent measurement units of a second size that is smaller than the measurement units of the first size.

6. The IV container of claim 1, wherein the upper fluid-containing portion is configured to contain a greater quantity of fluid than the lower fluid-containing portion is configured to contain.

7. The IV container of claim 1, wherein the upper fluid-containing portion and the lower fluid-containing portion include at least a portion made of a translucent material.

8. The IV container of claim 1, wherein the upper fluid-containing portion and the lower fluid-containing portion are made of a flexible material.

9. The IV container of claim 1, wherein the upper fluid-containing portion and the lower fluid-containing portion are made of glass.

10. The IV container of claim 1, wherein the upper fluid-containing portion and the lower fluid-containing portion have a substantially cylindrical shape.

11. The IV container of claim 1, wherein the upper fluid-containing portion and the lower fluid-containing portion each have a substantially flat shape when empty, each portion having a seam that is configured to seal in fluid contained therein.

12. The IV container of claim 1, wherein the plurality of ports includes two ports.

13. An IV container for precise measurement and dispensing of fluid contained in the IV container, the IV container comprising:
a flexible translucent upper fluid-containing portion configured to contain and measure a first quantity of fluid,
the flexible translucent upper fluid-containing portion having a first cross-sectional area,
the flexible translucent upper fluid-containing portion having a first plurality of fluid measurement markings along at least a portion of a side of the flexible translucent upper fluid-containing portion;
a flexible translucent lower fluid-containing portion in fluid communication with the flexible translucent upper fluid-containing portion, the flexible translucent lower fluid-containing portion configured to contain and measure a second quantity of fluid,
the flexible translucent lower fluid-containing portion having a second cross-sectional area that is less than the first cross-sectional area,
the flexible translucent lower fluid-containing portion having a second plurality of fluid measurement markings along at least a portion of a side of the flexible translucent lower fluid-containing portion;
a plurality of ports in fluid communication with the flexible translucent lower fluid-containing portion, the plurality of ports configured to enable input and output of fluids; and
a tab, connected to the flexible translucent upper large fluid-containing portion, the tab configured to be suspended from an IV stand.

14. The IV container of claim 13, wherein the flexible translucent lower fluid-containing portion is configured to contain and measure a second quantity of fluid that is less than the first quantity of fluid.

15. The IV container of claim 13, wherein:
the first plurality of fluid measurement markings along at least a portion of a side of the flexible translucent upper fluid-containing portion represent measurement units of a first size; and
the second plurality of fluid measurement markings along at least a portion of a side of the flexible translucent lower fluid-containing portion represent measurement units of a second size that is smaller than the measurement units of the first size.

16. The IV container of claim 13, further comprising:
a flexible translucent tapered intermediate fluid-containing portion in fluid communication with both the flexible translucent upper fluid-containing portion and the flexible translucent lower fluid-containing portion.

17. The IV container of claim 16, wherein the flexible translucent tapered intermediate fluid-containing portion has a third plurality of fluid measurement markings along at least a portion of a side of the flexible translucent tapered intermediate fluid-containing portion, each pair of neighboring markings of the third plurality of fluid measurement markings representing a same quantity of fluid.

18. The IV container of claim 13, wherein the flexible translucent upper fluid-containing portion and the flexible translucent lower fluid-containing portion have a substantially flat shape when empty, each portion having a seam that is configured to seal in fluid contained therein.
